(19) United States
(12) Patent Application Publication
(10) Pub. No.: US 2023/0266220 A1
(43) Pub. Date: Aug. 24, 2023

(54) METHOD FOR DETERMINING THE RHEOLOGICAL PARAMETERS OF A FLUID

(71) Applicants: UNIVERSITE GRENOBLE ALPES, Saint-Martin-d'Hères (FR); CENTRE NATIONAL DE LA RECHERCHE SCIENTIFIQUE, Paris (FR); INSTITUT POLYTECHNIQUE DE GRENOBLE, Grenoble (FR)

(72) Inventors: Guillaume Maîtrejean, Gières (FR); Denis Roux, Corenc (FR)

(73) Assignees: UNIVERSITE GRENOBLE ALPES, Saint-Martin-d'Hères (FR); CENTRE NATIONAL DE LA RECHERCHE SCIENTIFIQUE, Paris (FR); INSTITUT POLYTECHNIQUE DE GRENOBLE, Grenoble (FR)

(21) Appl. No.: 18/006,923

(22) PCT Filed: Jul. 20, 2021
(86) PCT No.: PCT/FR2021/051355

§ 371 Date: Jan. 26, 2023

(30) Foreign Application Priority Data
Jul. 27, 2020 (FR) 2007918

(51) Int. Cl. G01N 11/04

(52) U.S. Cl. CPC G01N 11/04; G01N 13/02

(57) ABSTRACT

The present invention relates to determining the rheological parameters of fluids, and, more particularly, by means of a method using a continuous jet droplet generator.

The present invention relates generally to the determination of the rheological parameters of fluids, regardless of their nature, and more particularly by means of a method implementing a continuous-jet droplet generator.

Determination of the rheological parameters of fluids is understood to mean, within the meaning of the present invention, the identification, for any type of fluid (whether Newtonian, shear-thinning, shear-thickening, viscoelastic or with threshold, etc.), of all the rheological properties of the fluids to be analyzed, such as, in particular, the surface tension, the density, the dynamic viscosity and the kinematic viscosity, the relaxation time, etc.

A continuous-jet droplet generator is understood to mean, within the meaning of the present invention, a continuous ink jet ejection device, usually designated by the acronym CIJ.

Understanding the flow properties of the fluids and measuring the associated rheological and physical properties are crucial both to research and industry.

The main quantities that characterize a fluid are its density, its surface tension and its rheological properties of viscosity and of elasticity. To determine these quantities, various measurement devices are necessary. Depending on the devices used, couplings or disturbances make measuring these properties difficult.

For example, the rheological properties of elasticity are disturbed by the surface tension and the inertias of the fluids and of the viscoelasticity measurement tools such as the rotational rheometers that are commonly used in research and in industry.

In order to determine the physical quantities of the fluids, the present invention relies on the development of a novel method for determining rheological parameters of fluids that implements a continuous-jet droplet generator of CIJ type and that uses a so-called “Data-Science” approach based on a dataset obtained from the CIJ method and the digital simulation of this method.

Upon the ejection of a fluid by the CIJ ejection method, three forces, inertial, viscous and interfacial (surface tension), are in competition and notably affect the morphology of the jet and of the droplets obtained. Under certain conditions, the morphology of the jet is thus unique (as illustrated by FIG. 4) and directly linked to the rheological properties of the fluid. The length from which the jet is broken is called break length. The broken jet exhibits droplets and, depending on the experimental conditions, satellites (secondary droplets of volume or volumes smaller than the main droplets).

In the present invention, the jet of fluid from the nozzle to the droplets of stabilized form will be called complete jet.

By ejecting a fluid using a suitable CIJ device, and by comparing its morphology to a dataset containing a vast range of jet morphologies through the “Data-Science” approach, it is possible to accurately determine the rheological properties of the fluid, that is to say its dynamic viscosity, its surface tension and its density.

The subject of the present invention is therefore a method for determining the rheological parameters of a fluid which comprises the following steps:
A) introduction of said fluid into a continuous-jet droplet generator comprising a tank maintained at a given pressure p₀ using a pump or any other pressurizing device and communicating via an inlet orifice with an ejection head, the temperature of which is controlled;
B) periodic stimulation, of amplitude A (in Volts) and of frequency F=1/T, of a piezoelectric actuator, such that said piezoelectric actuator disturbs the pressurized fluid in said ejection head;
C) ejection out of said ejection head, via an outlet nozzle, of the duly disturbed fluid, which takes the form of a jet;
D) obtaining, using a stroboscope at a given instant t, of a fixed and illuminated image of the complete jet;
E) recording of one or more photographs of all or part of said fixed and illuminated image of the complete jet, using a camera or a photographic device;
F) analysis of the photographs from the step E to extract therefrom a dataset descriptive of said jet;
G) determination of the rheological parameters of said fluid (1) for a given ejection nozzle, and for a given stimulation amplitude Aᵢ and pressure p₀ᵢ, i being a natural integer at least equal to 2, said determination of the rheological parameters being performed using a statistical method previously parameterized by using as training set a database containing the morphologies of known fluid jets.

The method according to the invention is capable of determining the rheological parameters of any type of fluid, whether Newtonian or Non-Newtonian.

The first step A) of the method according to the invention consists in introducing, into a continuous-jet droplet generator, a fluid for which the rheological parameters are to be determined. The method according to the invention is suited to any type of fluid, whether Newtonian, shear-thinning, shear-thickening, viscoelastic, with threshold, etc.

The continuous-jet droplet generator used in the context of the method according to the invention (also called device of CIJ type) comprises a tank maintained at a given pressure p₀ using a pump or any other pressurizing device and communicating via an inlet orifice with an ejection head, the temperature of which is controlled, as illustrated in FIG. 1.

The second step B of the method according to the invention consists in performing a periodic stimulation, of amplitude A (in Volts) and of frequency F=1/T, of a piezoelectric actuator, such that the latter disturbs the pressurized fluid in said ejection head. The pressurizing of the fluid makes it possible to control the flowrate of the fluid on its ejection.

Advantageously, the piezoelectric actuator is immersed in the pressurized fluid in said ejection head.

The third step C) of the method according to the invention consists in ejecting out of said ejection head, via an outlet nozzle, the fluid thus disturbed in the step B, which then takes the form of a jet of given morphology.

The fourth step D) of the method according to the invention is a step of obtaining, using a stroboscope at a given instant t, of a fixed and illuminated image of the complete jet.

Image of the complete jet is understood to mean, within the meaning of the present invention, an image of the jet of fluid from the nozzle to the droplets that has a form which is stabilized.

Then, using a camera or a photographic device, one or more photographs of all or part of the image of the complete jet, the position of which appears fixed by virtue of the stroboscopic illumination of said complete jet (Step E), is or are recorded. These images are then analyzed (Step F) to extract therefrom a dataset descriptive of said jet and compared to a database in order to extract therefrom the rheological properties.

In particular, this database is composed of the morphologies of jets of fluids of different viscosity and surface tension. It is therefore necessary to obtain the morphologies of a large number of fluid jets that have different and known viscosities and/or surface tensions. Since the morphology of the jets depends also on the parameters of the CIJ device, this database must be composed in the same conditions of ejection of the CIJ device. Moreover, the number of fluids that are known (that is to say for which all the rheological parameters are known, namely the viscosity or viscosities, the surface tension and the density) and available experimentally, is not enough to constitute the dataset. So, a digital simulation approach is necessary: for a given nozzle, the jets are generated digitally and validated experimentally using a few known real fluids, including standard fluids, by comparing the digital and experimental results. A faithful prediction of the digital model is thus absolutely necessary in order to have a reliable determination of the rheological properties.

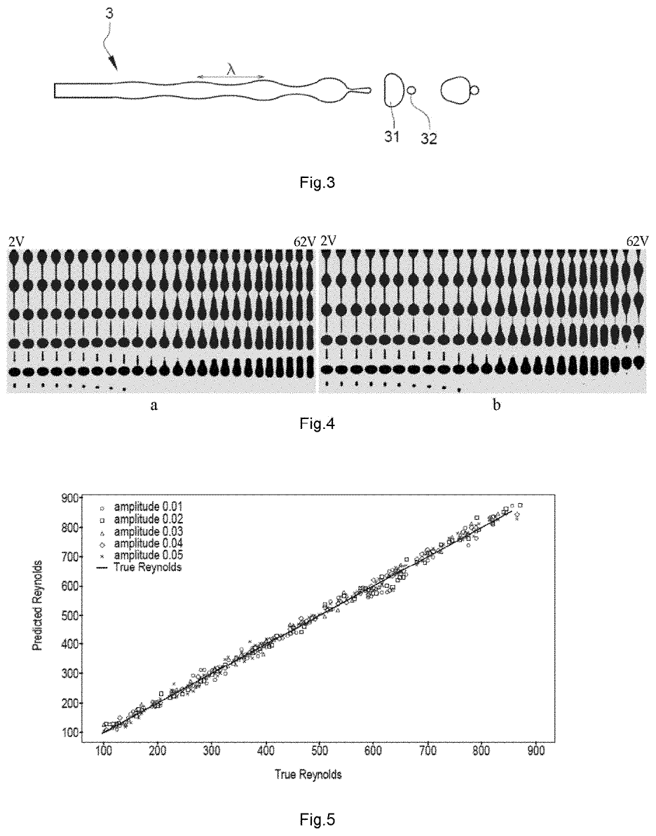

The morphologies of the jets are defined by the geometrical form taken by the free surface of the jet. It is possible to extract, from the geometrical form of the jet (as illustrated in FIG. 3), information such as the following properties (non-exhaustive list):
the diameter of the undisturbed jet,
the break length (smallest distance between the nozzle and the first droplet),
the volume of droplets,
the surface of droplets at a certain distance from the break,
the volume of the satellite or satellites,
the surface of the satellite or satellites at a certain distance from the break,
the dynamics of the satellite or satellites (slow, infinite or fast),
the wavelength.

The measurement of the rheological properties of the ejected fluid is done by comparing the morphology of the jet to those contained in a database mapping a vast range of rheological properties.

Thus, more particularly, the last step of the method according to the invention (Step G) is a step of comparison and interpolation of the dataset descriptive of the jet obtained in the step F.

This step F of comparison and interpolation is performed using a statistical algorithm for a given outlet nozzle, pressure p₀ᵢ and stimulation amplitude Aᵢ, with i being a natural integer at least equal to 3, so as to estimate/determine the rheological parameters of said fluid.

In other words, this step F relies on the statistical algorithm which is a machine learning algorithm that makes it possible to identify, from information obtained experimentally, the fluid present using databases grouping together a large number of known fluids.

Advantageously, the dataset descriptive of the jet can be the geometrical form of the jet or data extracted from said geometrical form of all or part of the complete jet. Thus, the determination of the rheological properties of the fluids that are analyzed using the method according to the invention is based on the geometrical form taken by the jet and, in particular, on the fact that this form takes on a unique character depending on the stimulation amplitude.

Advantageously, the database can comprise information obtained with real jets and/or obtained with jets generated by digital simulation (which are previously validated experimentally using standard fluids).

According to a first variant embodiment of the step G of the method according to the invention, the statistical algorithm can be based on a model of linear regression type. The parameters of the model will be determined previously by using, as training set, the database containing the morphologies of jets of known fluids.

According to a second variant embodiment of the step G of the method according to the invention, the statistical algorithm can be based on a model of artificial neural network type.

Preferably, the model of neural network type can comprise at least one layer of neurons, which will be previously trained by using, as training set, the database containing the morphologies of jets of known fluids.

The comparison and interpolation in the step G is thus based on statistical models for which the coefficients have been determined previously.

According to a first embodiment of the method according to the invention, the procedure is as follows:
the steps B to G are performed for two different stimulation amplitudes A₁ and A₂:
if the rheological parameters of the fluid estimated for each of these stimulation amplitudes A₁ and A₂ do not converge, the steps B to G are then reiterated with one amplitude A₃ or several other stimulation amplitudes A₁, i being a natural integer at least equal to 3, until a convergence of the rheological parameters of the fluid thus estimated is obtained.

According to a second embodiment of the method according to the invention, the procedure is as follows:
the steps B to G are performed for two different pressures p₀₁ and p₀₂;
if the rheological parameters of the fluid estimated for each of these pressures p₀₁ and p₀₂ do not converge, said steps B to G are then reiterated with one pressure p₀₂ or several other pressures p₀₁, i being a natural integer at least equal to 3, until a convergence of the rheological parameters of the fluid thus estimated is obtained.

Other advantages and particular features of the present invention will emerge from the following description, given as a non-limiting example and with reference to the attached figures and to the examples:

FIG. 1 is a schematic representation in cross-section of an example of continuous-jet droplet generator of CIJ type implemented in the method according to the invention;

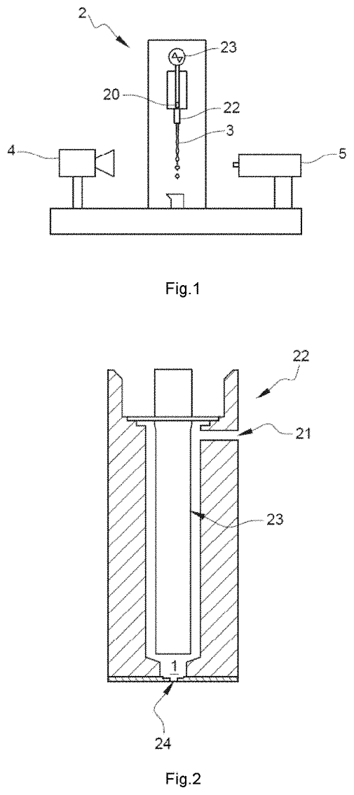

FIG. 2 is an enlarged view of the ejection head of the CIJ generator represented in FIG. 1;

FIG. 3 is an example of digital jet with the presence of droplets and of satellites;

FIG. 4 shows the morphologies of jets of 2 fluids of the same surface tension, density and viscosity with low velocity gradient, for different stimulations, the data being obtained with a CIJ device that is identical in both cases; the part a of [FIG. 4] shows the morphology of a fluid with Newtonian behavior (constant viscosity), whereas the part b of [FIG. 4] shows the morphology of a fluid with shear-thinning behavior (viscosity decreasing with the shear rate);

FIG. 5 shows the trend of the results of the Reynold numbers predicted (on the y axis) by the neural network versus the true Reynolds number of the jet (on the x axis).

FIGS. 1 and 2 show the experimental measurement system used in the context of the present invention: it is a continuous-jet droplet generator 2, or device of CIJ type. The fluid 1 for which the rheological properties are to be determined is contained in a tank 20 maintained under pressure by means of a pump (not represented in these figures) to ensure the flow. The pump is either pressure-controlled or flowrate-controlled. The fluid 1 to be analyzed arrives at the ejection head 22 of the generator 2 and exits in the form of a jet 3. The ejection head 22 is temperature-controlled via a thermostatically-controlled bath or any other temperature-controlled device. The ejected fluid 1 is stimulated using a piezoelectric actuator 23 prior to ejection, in order to increase the so-called Rayleigh Plateau instability which is responsible for the breaking of the jet 3. The jet 3 ejected by the device of CIJ type 2 and disturbed by the periodic stimulation of the piezoelectric actuator 23 generates droplets at a fixed frequency close to the disturbance. Using a stroboscope, it is then possible to obtain a fixed and illuminated image of the jet. The latter is then photographed by a photographic device 5 (or a camera). A portion or all of the jet 3 from the nozzle to the break (see [FIG. 3]) and the droplets generated are obtained by moving the photographic device (or the camera) along the jet. The morphology of the jet 3 is such as that shown by FIG. 3 which shows an example of digital jet with the presence of droplets 31 and of satellites 32 (a single satellite in [FIG. 3]). In the example of FIG. 3, the satellite 32 dynamic is slow because the satellite 32 is caught up by the droplet which precedes it.

### EXAMPLES

### Example 1: Use of the Device of CIJ Type to Generate Continuous Jets of Droplets of a Newtonian Fluid and of a Non-Newtonian Fluid; Study of their Morphologies

In order to determine the rheological parameters of a Newtonian fluid 1 (denoted A) with constant viscosity, a continuous-jet droplet generator 2, illustrated in FIGS. 1 and 2, is used to generate a continuous jet of droplets of fluid 1 (denoted A).

Then, the process is recommenced and the same continuous-jet droplet generator 2 is used to generate a continuous jet of droplets of a Non-Newtonian fluid 1 (denoted B), slightly shear-thinning with very high shear rate (greater than 300 000 s-1) in order also to determine therefrom its rheological parameters.

The fluids A and B have the same surface tension, the same viscosity with low shear rate and the same density. Thus, the difference between these two fluids lies solely in the shear-thinning nature of the fluid B.

The fluids A and B are ejected through the same devices of CIJ type with different stimulation amplitudes, the voltage of the piezoelectric actuator 23 varying from 2 V to 62 V. A photo of the jet 3 at the break is taken for each stimulation [FIG. 4], for the fluids A (FIG. 4a) and B (FIG. 4b).

Despite the very close rheological properties, the competition between the different inertial, viscous and interfacial (surface tension) forces that come into play upon the ejection of the fluid makes it possible to discriminate the fluids and a strong difference of geometrical form of the jet is observed for the high stimulation amplitudes.

### Example 2: Determination of the Viscosity of Fluids by Implementing the Second Variant Embodiment of the Step G of the Method According to the Invention, According to which the Statistical Algorithm is Based on a Model of Artificial Neural Network Type

This example illustrates the determination of the viscosity of fluids using the method according to the invention, in the case where the statistical algorithm used in the step G is based on a model of artificial neural network type.

The ejection nozzle 24 is selected and identical for all the digital and experimental jets generated by a device of CIJ type 2 as represented in FIGS. 1 and 2.

In this example, the average ejection velocity, the density and the surface tension are also fixed. Only the viscosity of the fluid varies and the Reynolds number is directly linked to it.

4005 jets of Newtonian fluids are then generated using digital fluid mechanics simulation software: for a Reynolds number at the nozzle outlet varying from 100 to 900, in increments of one, five stimulation amplitudes are simulated digitally. The results of the simulations are strictly compared to a few jets of real fluids in order to ensure the relevance of the result obtained.

From the geometrical form of the 4005 jets thus obtained, the following data are extracted for each jet, in order to constitute the database:
the length of the jet 3 before break,
the surface of the jet 3 before break,
the volume of the jet 3 before break,
for the first 6 droplets, the length, the maximum height, the volume and the surface of the droplet and the difference between it and the preceding one (for the first droplet, the difference between that and the jet is given).

80% of the dataset is selected randomly to constitute a training set for the training of said artificial neural network and the remaining 20% will constitute the test dataset.

FIG. 5 illustrates the results of predictions of the neural network from the test dataset. An excellent correlation is observed between the predicted Reynolds number and the true Reynolds number, with a relative mean error less than 3%.

This result shows that the method according to the invention makes it possible to accurately determine the rheological characteristics of the fluids.

1. A method of determining rheological parameters of a fluid, the method comprising:
a) introducing the fluid into a continuous-jet droplet generator comprising a tank maintained at a given pressure p₀ using a pressurizing device and communicating via an inlet orifice with an ejection head, a temperature of which is controlled;
b) periodically stimulating, at amplitude A in Volts and frequency F=1/T, a piezoelectric actuator, so that the piezoelectric actuator disturbs the pressurized fluid in the ejection head;
c) ejecting, via an outlet nozzle and out of the ejection head, the duly disturbed fluid, which takes the form of a jet;
d) obtaining, using a stroboscope at a given instant t, a fixed and illuminated image of the complete jet;
e) recording one or more photographs of all or part of the fixed and illuminated image of the complete jet using a camera or a photographic device;
f) analyzing the photograph or photographs from the recording to extract therefrom a set of data descriptive of the jet;
g) determining the rheological parameters of the fluid for a given ejection nozzle, and for a given stimulation amplitude Aᵢ and pressure p₀ᵢ, i being a natural integer at least equal to 2, the determination of the rheological parameters being performed using a statistical method previously parameterized by using as training set a database containing morphologies of known fluid jets.

2. The method as claimed in claim 1, wherein the piezoelectric actuator is immersed in the pressurized fluid in the ejection head.

3. The method as claimed in claim 1, wherein the statistical method is based on a linear regression model.

4. The method as claimed in claim 1, wherein the statistical method is based on an artificial neural network model.

5. The method as claimed in claim 4, wherein the neural network model comprises at least one layer of neurons.

6. The method as claimed in claim 1, wherein the dataset comprises data on a geometrical form of all or part of the complete jet.

7. The method as claimed in claim 1, wherein the dataset is based on parameters obtained from the geometrical form of all or part of the complete jet.

8. The method as claimed in claim 1, wherein the database comprises information obtained with experimental fluid jets and/or obtained with fluid jets generated by digital simulation.

9. The method as claimed in claim 1, wherein:
the periodic stimulation of the piezoelectric simulator, the ejection of the disturbed fluid, the obtaining of the illuminated image, the recording of the one more photographs, the analysis of the photograph or photographs, and the determination of the rheological parameters are performed with two different stimulation amplitudes A₁ and A₂;
if the rheological parameters of the fluid estimated for each of the stimulation amplitudes A₁ and A₂ do not converge, reiterating, the periodic stimulation of the piezoelectric simulator, the ejection of the disturbed fluid, the obtaining of the illuminated image, the recording of the one more photographs, the analysis of the photograph or photographs, and the determination of the rheological parameters with another amplitude A₃ or several other stimulation amplitudes Aᵢ, i being a natural integer at least equal to 3, until a convergence of the duly estimated rheological parameters of the fluid is obtained.

10. The method as claimed in claim 1, wherein:
the periodic stimulation of the piezoelectric simulator, the ejection of the disturbed fluid, the obtaining of the illuminated image, the recording of the one more photographs, the analysis of the photograph or photographs, and the determination of the rheological parameters are performed for two different pressures p₀₁ and p₀₂;
if the rheological parameters of the fluid estimated for each of the pressures p₀₁ and p₀₂ do not converge, reiterating the periodic stimulation of the piezoelectric simulator, the ejection of the disturbed fluid, the obtaining of the illuminated image, the recording of the one more photographs, the analysis of the photograph or photographs, and the determination of the rheological parameters with another pressure p₃ or several other pressures p0i, i being a natural integer at least equal to 3, until a convergence of the duly estimated rheological parameters of the fluid is obtained.

11. The method as claimed in claim 2, wherein the statistical method is based on a linear regression model.

12. The method as claimed in claim 2, wherein the statistical method is based on an artificial neural network model.

13. The method as claimed in claim 12, wherein the neural network model comprises at least one layer of neurons.

14. The method as claimed in claim 2, wherein the dataset comprises data on a geometrical form of all or part of the complete jet.

15. The method as claimed in claim 3, wherein the dataset comprises data on a geometrical form of all or part of the complete jet.

16. The method as claimed in claim 4, wherein the dataset comprises data on a geometrical form of all or part of the complete jet.

17. The method as claimed in claim 5, wherein the dataset comprises data on a geometrical form of all or part of the complete jet.

18. The method as claimed in claim 2, wherein the dataset is based on parameters obtained from the geometrical form of all or part of the complete jet.

19. The method as claimed in claim 3, wherein the dataset is based on parameters obtained from the geometrical form of all or part of the complete jet.

20. The method as claimed in claim 4, wherein the dataset is based on parameters obtained from the geometrical form of all or part of the complete jet.
